(19) United States
(12) Patent Application Publication
(10) Pub. No.: US 2026/0241803 A1
(43) Pub. Date: Aug. 20, 2026

(54) HYBRID-POWERED DRAIN CLEANER

(71) Applicant: Spartan Tool, L.L.C., Niles, MI (US)

(72) Inventor: Huairen ZHOU, South Bend, IN (US)

(21) Appl. No.: 19/537,208

(22) Filed: Feb. 11, 2026

Related U.S. Application Data
(60) Provisional application No. 63/759,860, filed on Feb. 18, 2025.

(51) Int. Cl. B60L 50/51; B60L 50/60; B60L 53/16

(52) U.S. Cl. CPC B60L 50/51; B60L 50/60; B60L 53/16; B60L 2240/547

(57) ABSTRACT

A hybrid-powered drain cleaner can include a motor (e.g., DC brushless motor) powered by a battery or by a corded source (e.g., AC electricity from an outlet). In at least some examples, the battery can remain connected (e.g., both mechanically and electrically) to the drain cleaner when the battery is being used to power the motor and also when the motor is being powered by a corded source. In addition, when the drain cleaner is connected to a corded source, the battery can be charged while connected to the machine and without having to remove the battery for charging, such as with a separate docking station. In some instances, the battery can be charged via the corded electricity source even while the motor is operating, and charging can be controlled based on the power needs of the motor.

### CROSS-REFERENCE TO RELATED APPLICATIONS

This application claims priority to U.S. Application No. 63/759,860, titled “HYBRID-POWERED DRAIN CLEANER,” filed Feb. 18, 2025, which is hereby incorporated by reference in its entirety.

### BACKGROUND

Drain cleaners are important tools for maintaining the functionality of plumbing systems. In at least some drain cleaners, a cable (e.g., often referred to as a “snake”) is fed into a pipe and used to dislodge a blockage, such as by rotating the cable and traversing the cable into the blockage. Traditional manual methods of clearing blockages can be inefficient and labor-intensive and can sometimes be ineffective at clearing certain types of blockages. A motorized drain cleaner that uses a motor to operate the cable can be more efficient and more effective. Some motorized drain cleaners can be powered by a corded electric source, while others can be powered by a battery.

### SUMMARY

The present disclosure is directed, in part, to hybrid-powered drain cleaners substantially as shown in and/or described in connection with at least one of the figures, and as set forth more completely in the claims.

A high-level overview of various aspects of the present technology is provided in this section to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In aspects set forth herein, and at a high level, the technology described herein relates to a hybrid-powered drain cleaner that includes a power module configured to enable a motor to be powered by a rechargeable battery or by an external power source (e.g., AC electricity from an outlet), where the battery can remain connected to the drain cleaner during both modes of operation and can be charged without removal. The power module may include a controller that manages power distribution between the motor and battery charging components, distributing a first amount of power to the battery charging components and a second amount of power to the motor when connected to an external power source. The controller may adapt the power distribution based on a state of the motor (e.g., a lower power state, higher power state, etc.), an amount of power available from the external power source, and/or one or more control signals. The power module may include a converter configured to convert AC power received through a first connector to DC power for use by the motor (e.g., a DC brushless motor) and the battery charging components. The drain cleaner may include a foot pedal (e.g., an air actuated foot pedal) and/or a start/stop input device coupled to the power module, where releasing the foot pedal or selecting the start/stop input device may initiate a braking operation on the motor that transmits power to the battery charging components for regenerative charging in some examples. The power module may be mounted to a frame of the drain cleaner or to a trunnion assembly that supports a cylindrical drum housing a flexible cable, and may attach by one or more mechanical fasteners (e.g., threaded fasteners) to facilitate quick servicing or replacement.

### BRIEF DESCRIPTION OF THE DRAWINGS

The present systems and methods for a hybrid-powered drain cleaner are described in detail below with reference to these figures.

FIG. 1 depicts a first view of a first style of a drain cleaner.

FIG. 2 depicts a second view of the first style of drain cleaner.

FIG. 3 depicts a frame of the first style of drain cleaner isolated and connected to a power module.

FIG. 4 depicts a first view of a second style of drain cleaner.

FIG. 5 depicts a second view of the second style of drain cleaner.

FIG. 6 depicts a frame of the second style of drain cleaner isolated and connected to an example power module.

FIG. 7 depicts a third style of drain cleaner.

FIG. 8 depicts a second view of the third style of drain cleaner.

FIG. 9 depicts a frame of the third style of drain cleaner isolated and connected to a power module.

FIG. 10 illustrates an example power module suitable for use with a hybrid-powered drain cleaner.

FIG. 11 illustrates a block diagram of an example power module suitable for use with a hybrid-powered drain cleaner.

FIG. 12 illustrates a flow diagram of an example method of power distribution for a hybrid-powered drain cleaner.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

This detailed description is related to a hybrid-powered drain cleaner, in which the motor (e.g., DC brushless motor) can be powered by a battery or by a corded source (e.g., AC electricity from an outlet). In at least some examples, the battery can remain connected (e.g., both mechanically and electrically) to the drain cleaner when the battery is being used to power the motor and also when the motor is being powered by a corded source (e.g., when the battery is depleted or otherwise unable to power motor operation). In addition, when the drain cleaner is connected to a corded source, the battery can be charged while connected to the machine and without having to remove the battery for charging, such as with a separate docking station. In some instances, the battery can be charged via the corded electricity source even while the motor is operating. That is, the drain cleaner can manage power distribution, such that the electricity received from the corded source can be used to both power the drain cleaner and charge the battery.

Conventional drain cleaners are sometimes powered using a rechargeable battery. However, conventional drain cleaners typically require the battery to be removed from the drain cleaner and charged remotely from drain cleaner (e.g., at a docking station). In addition, conventional drain cleaners might only be powered by a battery without also providing an option to power by another power source (e.g., corded power source). As such, if a charged battery is not available, the conventional drain cleaner might not be usable.

In contrast to conventional drain cleaners, a drain cleaner of the present disclosure includes a power module with an integrated battery (e.g., Li-ion battery pack) that does not need to be removed for charging. As such, the battery can remain attached to the machine and can be charged using the corded power connected to the drain cleaner, including while the motor is being powered by the corded power. Among other things, the ability to charge the battery while connected to the drain cleaner provides a more convenient solution by removing the need for separate charging equipment (e.g., docking station, additional cords, etc.) and by enabling charging while the drain cleaner is in use and powered using the corded source. In addition, the power module can, in at least some examples, be easily switched out for servicing and/or replacement by disconnecting and connecting common fasteners.

In at least some examples, a drain cleaner of the present disclosure includes a power controller (e.g., Microcontroller Unit or “MCU”) that controls power distribution associated with the drain cleaner and the power module. For example, when the power module is attached to a corded power source (e.g., plugged in to an AC outlet) the power controller can assess the power needs of the drain cleaner and effectively distribute power to the motor and/or to the charging components associated with the rechargeable battery.

The drain cleaner can include various other functionality. For instance, in at least some examples, braking of the motor can be used to recharge the battery (e.g., in addition to the power from the corded source). For example, the drain cleaner can include an E-stop that, when pressed, can signal to the drain cleaner to initiate a braking force on the motor and power regeneration or charging to the battery.

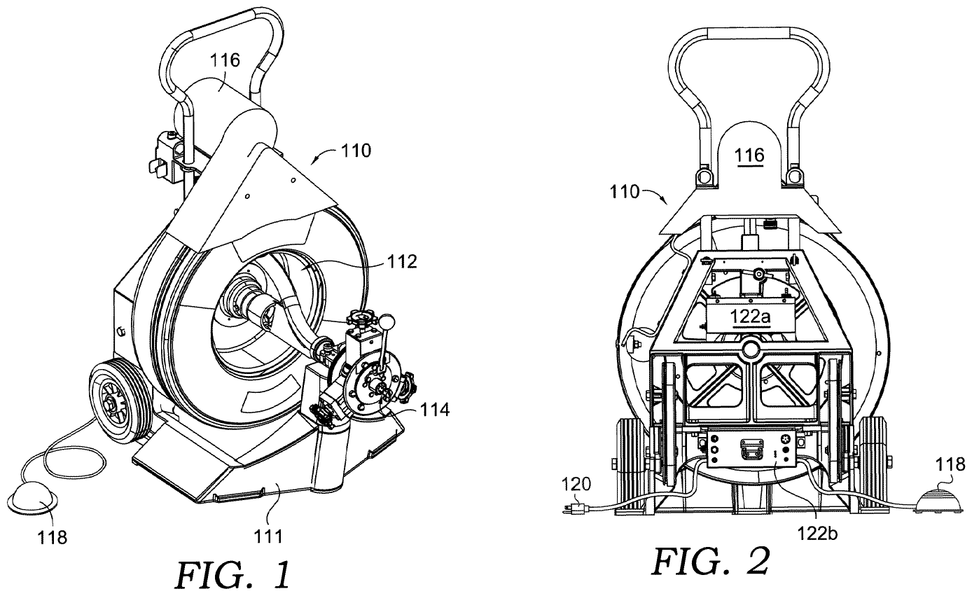

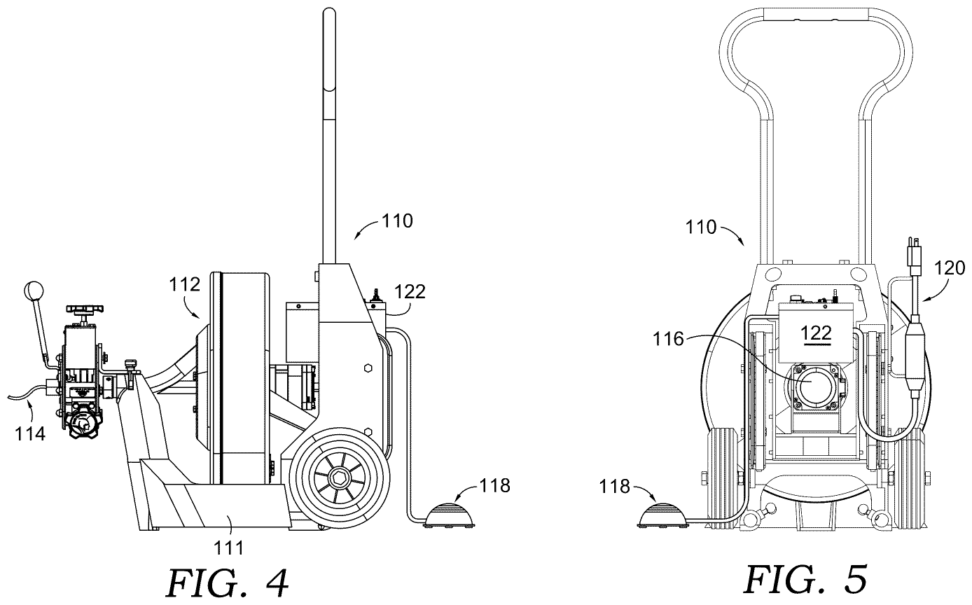

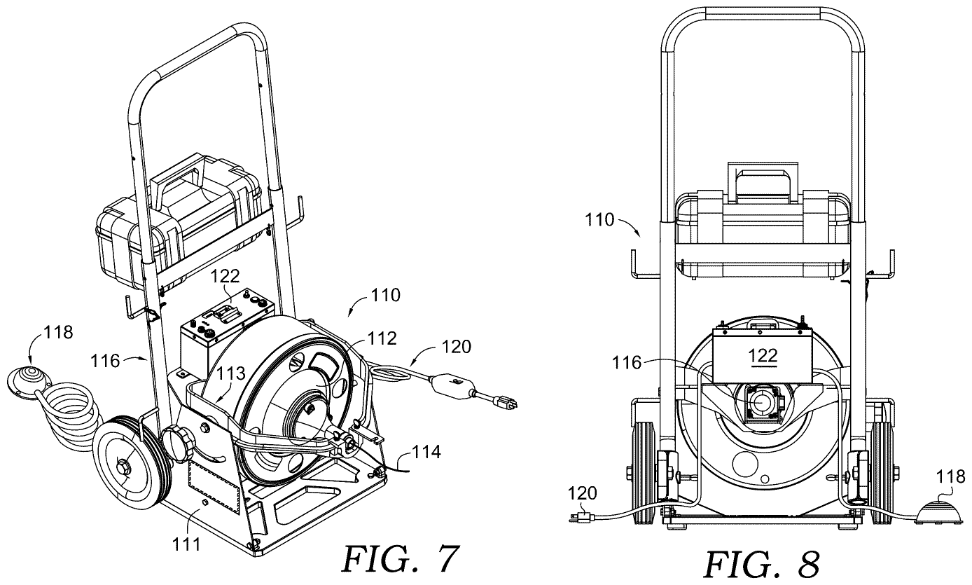

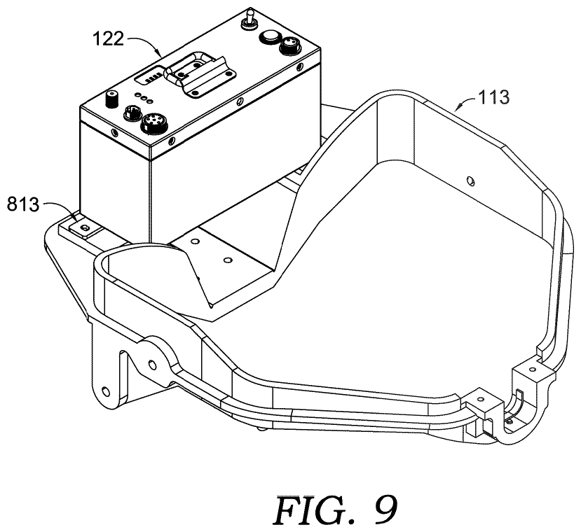

Referring to FIGS. 1-9, various examples of drain cleaners 110 are illustrated based on examples of the present disclosure. FIGS. 1-3 illustrate different views associated with a first style of drain cleaner; FIGS. 4-6 illustrate different views associated with a second style of drain cleaner; FIGS. 7-9 illustrate different views associated with a third style of drain cleaner. Among the various figures, like components are identified by the same reference number. For brevity and conciseness, similar components might not be described multiple times, and it is understood that similar components can operate in a similar manner with respect to each example drain cleaner 110. FIGS. 1-9 illustrate different drum-style drain cleaners, and examples of the present disclosure can be used with other styles of drain cleaners that might not include a drum-style and that can still include a hybrid-power system.

In examples, and referring to FIGS. 1-9, the drain cleaners 110 can include a frame 111 that supports various components, such as a cylindrical drum 112 that houses a flexible cable 114. The drum 112 can be mounted on a rotatable axis that allows the drum to spin, which in turn can pay out or retract the cable 114. In some examples, such as in FIGS. 7 and 8, the drain cleaner can include a trunnion assembly 113 that supports the drum 112 and one or more other components.

In addition, the drain cleaner 110 can include a motor 116 (e.g., DC brushless motor) that can rotate the drum 112 and cause the cable 114 to traverse a pipe (not shown). In at least some instances, the drain cleaners 110 can include a foot pedal (e.g., air actuated foot pedal, such as an air bob) that, when pressed, can control operations of the motor 116. Among other things, the foot pedal 118 can allow for hands-free operation. In some examples, the release of the foot pedal 118 may provide a command to the motor 116 to brake. In addition, the drain cleaner 110 can be connected to a power cable 120, which can provide electrical power from an outlet (e.g., 110/120 volt).

In examples, any of the drain cleaners 110 in FIGS. 1-9 can include a hybrid-powered drain cleaner, in which the motor 116 (e.g., DC brushless motor) can be powered by a battery or by a corded source (e.g., AC electricity from an outlet provided through the cable 120 and converted to DC). For example, any of the drain cleaners 110 can include a power module 122. In at least some instances, the power module 122 can include a rechargeable battery (e.g., 48V Li-ion battery pack) that does not need to be removed for charging. For example, the battery does not need to be disconnected from the power module 122 or from the drain cleaner 110 to be charged. As such, the battery can remain attached to the machine and can be charged using the corded power (e.g., via power cable 120) connected to the drain cleaner, including while the motor is being powered by the corded power.

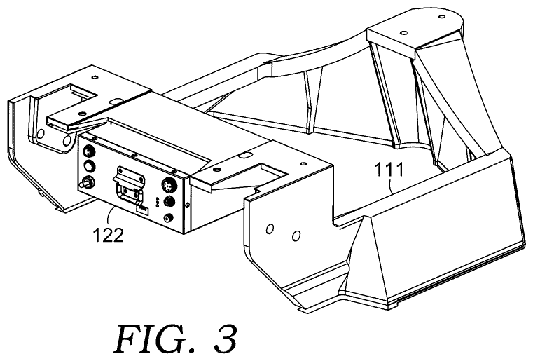

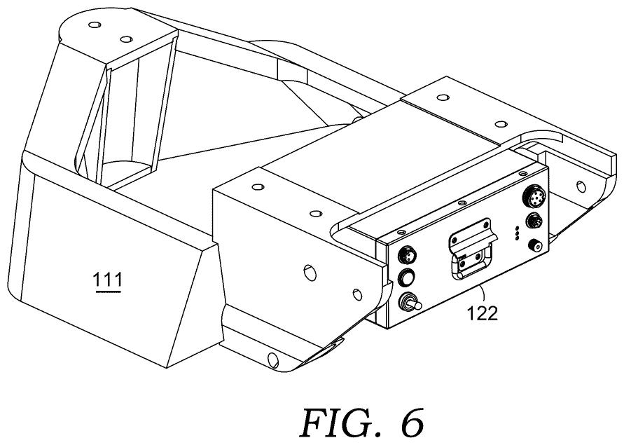

A power module 122 can be coupled to the drain cleaner 110 in various manners. For example, in FIGS. 1-6, in association with the first and second style of drain cleaner, the power module 122 can be mounted to the respective frames 111, and this can be seen in at least FIG. 3 and FIG. 6. In other examples, such as in FIGS. 7-9, the power module 122 can be mounted to other parts of the drain cleaner 110, such as to the trunnion assembly 113. These are just examples, and the power module 122 (or components thereof) can be mounted to other parts of the drain cleaners 110.

In at least some examples, the power module 122 can attach to the drain cleaner 110 by fasteners (e.g., threaded fasteners). As such, removing the power module 122, such as for servicing or replacement, is simple and easy.

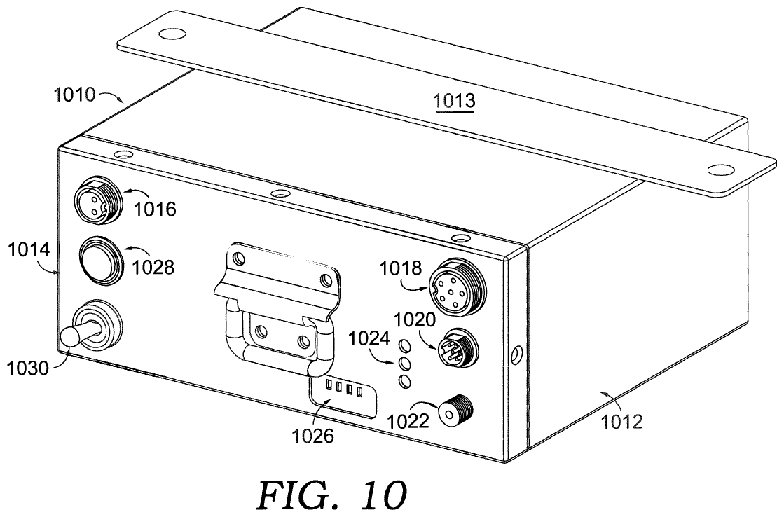

Referring to FIG. 10, an example of a power module 1010 is depicted, and the power modules 122 can include at least some of (e.g., all of or most of) the same elements described with respect to the power module 1010. In at least some examples, the power module 1010 includes an outer cover or encasement 1012 that can contain the battery, battery charging components, power-management controls (e.g., power controller such as an MCU), power converter (e.g., to convert AC power to DC power), and the like. In at least some examples, the battery is a 48V Li-ion rechargeable battery, or any other rechargeable battery that can be used to power the motor 116. The battery charging components can include, among other things, transformer(s), rectifier(s), filters, regulators, resistors, and/or other components that are operable to use power received by the power module to charge the battery. In examples, the power module 1010 includes a control panel 1014, which can include various controls, ports, LEDs, and/or other inputs/outputs associated with the drain cleaner 110 and/or power management of the drain cleaner 110.

In at least some examples, the power module 1010 can attach to the drain cleaner 110 by a mounting bracket 1013, such as to a frame portion of the drain cleaner. For example, the bracket 1013 can connect to the frame 111 in FIGS. 1-6. The bracket 1013 can be modified and/or other mounting structures can be used, such as when the power module 1010 is mounted in a different orientation and/or to a different portion of the drain cleaner 110. For example, in the example of FIGS. 7-9 the power module 122 is mounted (e.g., to the trunnion assembly 113) in a different orientation and via a different bracket 813.

In examples, the control panel 1014 can include a first connector 1016 for connecting to a power cable, such as 120. The first connector 1016 can include a two-prong threaded port, or any other receptacle or connector type for connecting to a cable (e.g., for transmitting power). In some examples, the first connector 1016 can also connect (e.g., inside the power module 1010) to a power controller, converter (e.g., for converting AC power to DC power), battery charging components, or other components inside the power module 1010.

In at least some examples, the control panel 1014 can include a second connector 1018 for connecting to a power cable (not shown), which can connect to and transmit power between the motor (e.g., motor 116) and the power module 1010. For example, a cable connected to the second connector 1018 can transmit DC power from the power module 1010 to the motor. The DC power can be from a battery and/or from AC power received through the first connector 1016 and converted to DC power. In some examples, the second connector 1018 can also connect to a power controller or other components inside the power module 1010.

In at least some examples, the control panel 1014 can include a third connector 1020 (e.g., input/output device) for connecting to a cable for transmitting data between the power module 1010 and the motor (e.g., motor 116). For example, a cable connected to the third connector 1020 can send operation signals to the motor (e.g., on/off, forward/reverse, etc.) and/or can receive signals that indicate or represent status information from the motor 116. In some examples, the third connector 1020 can also connect to a power controller or other components inside the power module 1010.

In at least some examples, the control panel 1014 can include a fourth connector 1022 for connecting to a foot pedal (e.g., the foot pedal 118, which can include an air actuator, such as an air bob), and the fourth connector 1022 can also connect to a power controller or other components inside the power module 1010. In some examples, the release of the foot pedal results in a command being sent through the fourth connector 1022 for the motor 116 to brake (e.g., regenerative braking through controlled energy recovery, mechanical braking, etc.).

Any of the connectors 1016, 1018, 1020, and 1022 can include a connector type that is usable in wet or dusty or other conditions that might otherwise disrupt or impair or otherwise negatively affect the transmission of data, power, etc.

The control panel 1014 can include various input and/or output devices or components that can be used to operate and/or to provide information related to the drain cleaner 110 and/or the power module 1010. For example, the control panel 1014 can include LEDs 1024 (or some other output component) to indicate a status of the motor 116. In some examples, the control panel 1014 can include LEDs 1026 (or some other output component) to provide status information related to the battery (e.g., charging status). In some examples, the control panel 1014 can include a start/stop input component 1028 (e.g., push button) for starting and/or stopping operations of the drain cleaner and/or for turning the drain cleaner on and off. In some examples, during operation of the motor, the actuation of the start/stop input component 1028 commands the machine to brake. In addition, the control panel 1014 can include a forward/reverse input component 1030 for controlling a direction of the motor. Any of the components (e.g., LEDs 1024, LEDs 1026, start/stop input component 1028, and/or forward/reverse input component 1030) can be coupled with the power controller or other components associated with the power module 1010.

In at least some examples, the drain cleaner 110 can include a power controller (e.g., MCU) configured to manage power and other operations associated with the drain cleaner. For example, when a power cable is coupled to the connector 1016 and power (e.g., electrical power) is being provided from a cabled power source (e.g., wall outlet providing 110V/120V), the power controller can determine whether to distribute power (e.g., AC power converted to DC power) to the motor 116 and/or to the battery (e.g., for recharging). As such, the battery can remain connected (e.g., both mechanically and electrically) to the drain cleaner when the battery is being used to power the motor and also when the motor is being powered from power provided by a corded source (at which time at least some power can be used to recharge the battery). Stated differently, the battery can be charged while connected to the machine and without having to remove the battery for charging and no separate charging dock is required.

In at least some examples, the power controller can be electronically coupled to the components of the power module 1010, such as to the battery and to the various components that receive data and/or power through the control panel 1014 and that output signals (e.g., the LEDs) and/or other data. For example, the power controller can be coupled to the connectors 1016, 1018, 1020, and 1022; to the buttons or switches 1028 and 1030; to the LEDs 1024 and 1026; and to one or more other components (e.g., battery charging components, power converting components, etc.). As such, the power controller can receive signals indicating whether power is being received through the connector 1016, as well as receive signals via the connector 1020 indicating the status of the motor. Based on the signals received through the connector 1020 (e.g., signals indicating or representing a status of the motor), the power controller can distribute power received from the cabled source and through the connector 1016 (e.g., AC power converted to DC) based on the needs of the motor. For example, if based on the signals the motor is operating in a low power state (e.g., when initially turned on; when limited or lower resistance is met by the cable; etc.), then the power controller can (e.g., based on programmed instructions) distribute a first amount of power (e.g., AC power converted to DC) to the motor and a second amount of power to the battery charging components. In at least some examples, when the motor is operating at a higher power state (e.g., based on the signals received by the power controller), such as when more power is needed to operate the cable (e.g., more power is needed to rotate the cable to unclog a pipe) the power controller can distribute more power to the motor (e.g., increasing the first amount of power) and less power (or no power) to the battery or battery charging components. By way of non-limiting example, when connected to a 500 W external power source, the controller may initially allocate approximately 50 W to the motor and the remainder to battery charging, and subsequently adjust the distribution (e.g., 300 W motor/ 200 W charging) as cable load increases. In yet another example, the power controller can determine when to provide only battery-supplied power to the motor 116. For example, the power controller can receive a signal (or determine that no signal is being received), indicating that no power or insufficient power (e.g., corded power) is being received through the first connector 1016, and based on the signal (or lack of signal), the power controller can distribute power from the battery to the motor (e.g., from the battery and to the motor by way of the connector 1018).

The drain cleaner can include various other functionality, which may be enabled at least in part by the power controller. For instance, in at least some examples, braking of the motor can be used to recharge the battery. For example, when the start/stop input component 1028 is pressed and the foot pedal is released, power regeneration can be initiated, in which a braking force is applied to the motor, which in turn can be used to recharge the battery.

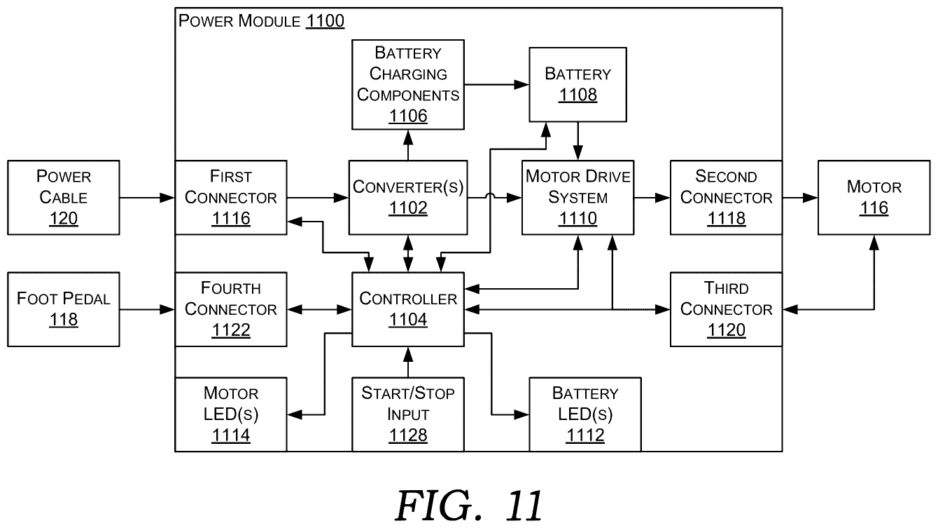

Referring to FIG. 11, FIG. 11 illustrates a block diagram of an example power module 1100 according to some aspects of the present disclosure. In the example shown in FIG. 11, the power module 1100 includes a converter 1102, a controller 1104, battery charging components 1106, a battery 1108, a motor drive system 1110, one or more battery LEDs 1112, and one or more motor LEDs 1114. The power module 1100 also includes a first connector 1116, a second connector 1118, a third connector 1120, and a fourth connector 1122. In some examples, the first connectors 1116, 1118, 1120, 1122 may include a connector type that is usable in wet or dusty or other conditions that might otherwise disrupt or impair transmission of data or power. It should be understood that the power module 1100 shown in FIG. 11 is an example, and the power module 1100 may include additional components or fewer components depending on the implementation.

In some examples, the power module 1100 may include an outer cover or encasement that may contain and protect the various components from wet or dusty or other conditions that might otherwise disrupt or impair or otherwise negatively affect the transmission of data, power, etc. In at least some examples, the power module 1100 may be implemented using a split configuration where at least some components of the power module 1100 (e.g., battery charging components 1106, battery 1108, etc.) are included in a first section and at least some components of the power module 1100 (e.g., controller 1104, etc.) are included in a second section that is separate from the first section. The sections of the power module 1100 may include respective covers and be communicatively coupled via one or more cables that may be used to exchange power and/or data signals between the sections. In some aspects, the power module 1100 may be coupled to a drain cleaner using one or more common fasteners such that the power module 1100 may be easily switched out for servicing and/or replacement by disconnecting and connecting the common fasteners.

With continued reference to FIG. 11, the power module 1100 may receive external power through a first connector 1116, which may be connected to the power cable 120. In some aspects, the first connector 1116 may include a two-prong threaded port, or any other receptacle or connector type for connecting to a cable (e.g., for transmitting power). In some examples, the first connector 1116 may be a receptacle configured to connect to the power cable 120, and the power cable 120 may be configured to be coupled to an external power source (e.g., an AC electrical power source). As further shown in FIG. 11, the first connector 1116 may be coupled to the converter(s) 1102.

The converter(s) 1102 may be configured to convert incoming power (e.g., AC power) to a suitable form (e.g., DC power) for use by the system components. In some aspects, the converter(s) 1102 may include one or more transformers, rectifiers, voltage regulators, and/or filtering components to facilitate the conversion of AC power to DC power. In some examples, the converter(s) 1102 may also include protection circuitry (e.g., surge protectors, fuses, etc.) to safeguard the power module 1100 and connected components from power fluctuations or electrical faults. In the example shown in FIG. 11, the converter(s) 1102 may be further connected to the controller 1104, the battery charging components 1106, and the motor drive system 1110.

As further shown in FIG. 11, the controller 1104 may be coupled to multiple components including the converter(s) 1102, the battery charging components 1106, the battery 1108, and the motor drive system 1110. The controller 1104 may manage power distribution for the system. For example, the controller 1104 may determine how much power to allocate to the motor 116 (e.g., via the motor drive system 1110) and how much power to direct to the battery charging components 1106 for recharging the battery 1108. The controller 1104 may be configured to distribute, from power received from the external power source through the first connector 1116 (and converted by the converter(s) 1102), a first amount of power to the battery charging components 1106 and a second amount of power to the motor 116.

The battery charging components 1106 may manage the charging of the battery 1108 using power received through the converter(s) 1102. The battery charging components 1106 may include, among other things, transformer(s), rectifier(s), filters, regulators, resistors, and/or other components that may be operable to use power received by the power module 1100 to charge the battery 1108. In at least some examples, the battery 1108 may be a rechargeable battery (e.g., Li-ion battery pack or any other rechargeable battery) that may be used to power the motor 116. In some aspects, the capacity of the battery 1108 is configured based on motor power requirements, expected duty cycles, operational run-time targets for the drain cleaner, and/or other requirements for the drain cleaner.

In the example shown in FIG. 11, the motor drive system 1110 may control the operation of and deliver power to the motor 116 through a second connector 1118. In some examples, the motor 116 may be a DC brushless motor. The motor drive system 1110 may receive power from the converter(s) 1102 and/or the battery 1108 and may deliver the appropriate power to the motor 116. In some aspects, the motor drive system 1110 may include circuitry configured to regulate voltage, current, and/or frequency supplied to the motor 116 based on operational requirements. The motor drive system 1110 may also include control logic configured to manage motor speed, torque, and direction in response to signals received from the controller 1104. In some examples, the third connector 1120 may provide a data connection between the motor 116 and the motor drive system 1110, and the motor drive system 1110 may receive one or more signals that may be indicative of a state of the motor 116. The motor drive system 1110 may adapt operation of the motor 116 based on the signal(s) from the motor 116.

In the example shown in FIG. 11, the power module 1100 may include a fourth connector 1122 that may be connected to the foot pedal 118, allowing the controller 1104 to receive input signals for controlling motor operations. The foot pedal 118 may be a pneumatic foot pedal (e.g., air actuated foot pedal), for hands-free operation. In some aspects, during operation of the drain cleaner, a user may release the foot pedal 118, which may provide a signal through the fourth connector 1122 to the controller 1104 and a braking operation may be applied to the motor 116, which may transmit power to the battery charging components 1106.

In the example shown in FIG. 11, the power module 1100 may include a start/stop input 1128 that may be connected to the controller 1104, enabling user control over the operation of the drain cleaner. In at least some examples, based on the start/stop input 1128 being selected, a braking operation may be applied to the motor 116, which may transmit power to the battery charging components 1106.

In some aspects, the battery 1108 may support fast charging and the power module 1100 may be configured to support fast charging of the battery 1108 when external power is provided through the power cable 120 (e.g., during operation). For example, the controller 1104 and/or battery charging components 1106 may manage charging behavior by regulating charging current supplied to the battery 1108 and protecting the battery 1108 based on system conditions. In some examples, the battery 1108 may include battery cells designed to support fast charging (e.g., low DC internal resistance battery cells with chemistry optimized for power density and thermal stability) and a battery management system (BMS) configured to monitor the state of charge of the battery 1108, temperature, and other parameters to determine when fast charging conditions are appropriate and to adjust the charging rate accordingly. In some aspects, the battery 1108 may include a continuously stable thermal structural design and implement a cell balancing strategy.

With continued reference to FIG. 11, the power module 1100 may also include battery LED(s) 1112, which may provide status information related to the battery 1108 (e.g., charging status) and/or motor LED(s) 1114, which may indicate a status of the motor 116. In some aspects, the controller 1104 may receive one or more signals from the battery 1108 indicative of a status and may control operation of the battery LED(s) 1112 accordingly. Similarly, the controller 1104 may receive one or more signals from the motor 116 (e.g., via the third connector 1120) indicative of a status and may control operation of the motor LED(s) 1114 accordingly. In some aspects, the power module 1100 may also include a forward/reverse input component (not shown in FIG. 11) that is coupled to the controller 1104 and may provide one or more signals for controlling a direction of the motor 116.

During use of the drain cleaner that includes the power module 1100, the controller 1104 may be configured to adapt the power distributed to the battery 1108 (e.g., via the battery charging components 1106) (referred to herein as the “first amount of power”) and the amount of power distribute to the motor 116 (e.g., via the motor drive system 1110) (referred to herein as the “second amount of power”) based on various factors. For example, the power module 1100 may adapt the first amount of power and the second amount of power based on a change in the state of the motor 116, one or more signals received from the motor 116, an amount of power received via the power cable 120, or other factors. In some examples, the third connector 1120 may provide a data connection between the motor 116 and the controller 1104, and the controller 1104 may receive one or more signals from the motor 116 that may be indicative of a state of the motor 116. In some aspects, the controller 1104 may utilize the signal(s) received from the motor 116 when determining the distribution of power between the battery 1108 and the motor 116.

In some aspects, the controller 1104 may be configured to increase the second amount of power and decrease the first amount of power based on a signal from the motor 116 indicating that the motor 116 is operating at a higher power state (e.g., when more power is needed to rotate the cable 114 to unclog a pipe or when increased resistance is encountered). Conversely, the controller 1104 may decrease the second amount of power and increase the first amount of power based on a signal from the motor 116 indicating that the motor 116 is operating at a lower power state (e.g., when initially turned on, when limited resistance is met by the cable 114, or when the motor 116 is idling). In some examples, the controller 1104 may adapt the first amount of power and the second amount of power based on the motor 116 transitioning from a first state to a second state. For example, the controller 1104 may be configured to increase the second amount of power and decrease the first amount of power based on the motor 116 transitioning from a lower power state to a higher power state, and the controller 1104 may be configured to decrease the second amount of power and increase the first amount of power based on the motor 116 transitioning from a higher power state to a lower power state. In at least some examples, the controller 1104 may be configured to increase the first amount of power based on the motor 116 being turned off and power being received from the external power source, thereby directing more power to the battery charging components 1106 when the motor 116 is not consuming power. The controller 1104 may also be configured to distribute power from the battery 1108 to the motor 116 when power is not being received from the external power source through the first connector 1116.

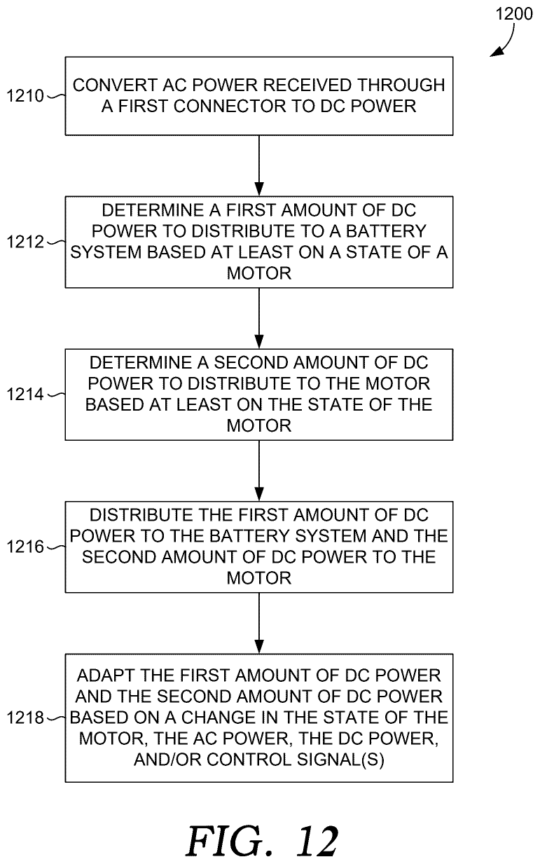

Referring to FIG. 12, FIG. 12 illustrates a flow diagram of a method 1200 of power distribution for a hybrid-powered drain cleaner according to some aspects of the present disclosure. Each block of method 1200, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method 1200 is described, by way of example, with respect to the FIGS. 1-11. However, this method may additionally or alternatively be executed by any one system, or any combination of systems, including, but not limited to, those described herein. In some aspects, the method 1200 may be performed by a controller (e.g. power controller) of the power module 122 described with reference to FIGS. 1-9, a controller of the power module 1000 described with reference to FIG. 10, or the controller 1104 of the power module 1100 described with reference to FIG. 11, or by another suitable controller or processing device.

The method 1200, at block 1210, includes converting AC power received through a first connector to DC power. In some aspects, one or more converters (e.g., converter(s) 1102) may perform the conversion of AC power received at a first connector of the power module to DC power. In some aspects, the converter(s) may include one or more transformers, rectifiers, voltage regulators, and/or filtering components to facilitate the conversion of AC power to DC power. The DC power produced by the converter(s) 1102 may then be available for distribution to the battery charging components and/or to the motor.

The method 1200, at blocks 1212 and 1214, includes determining a first amount of DC power to distribute to a battery system based at least on a state of the motor and determining a second amount of DC power to distribute to the motor based at least on the state of the motor. In some examples, the battery system comprises battery charging components (e.g., battery charging components 1106) and/or the battery (e.g., battery 1108) itself. In some aspects, the controller may determine that the motor is in a first state and may determine the first amount of DC power to distribute to the battery system based at least on the motor being in the first state. In some aspects, the first state may comprise an off state, a low power state (e.g., when the motor is initially turned on, when limited resistance is met by the cable, or when the motor is idling), or a high power state (e.g., when more power is needed to rotate the cable to unclog a pipe or when increased resistance is encountered). In some examples, the first state may correspond to a level of power requirements for the motor at a point in time. The controller may be configured to determine the state of the motor based on one or more signals from the motor and/or one or more signals from a motor drive system.

The method 1200, at block 1216, includes distributing the first amount of DC power to the battery system and the second amount of DC power to the motor. In some aspects, the controller may distribute the first amount of DC power from the converter(s) to the battery system and the second amount of DC power from the converter(s) to the motor drive system. The battery system may use the first amount of DC power to charge the battery, and the motor drive system may use the second amount of DC power to operate the motor. The distribution of the first amount of DC power and the second amount of DC power may occur simultaneously, enabling the battery to be charged while the motor is operating.

The method 1200, at block 1218, includes adapting the first amount of DC power and the second amount of DC power based on a change in the state of the motor, the AC power, the DC power, and/or one or more control signal(s). In some aspects, the controller may be configured to adapt the first amount of DC power and the second amount of DC power based on the motor transitioning from the first state to a second state. For example, where the motor transitions from a lower power state to a higher power state, the controller may be configured to decrease the first amount of DC power and increase the second amount of DC power. Conversely, where the motor transitions from a higher power state to a lower power state, the controller may be configured to increase the first amount of DC power and decrease the second amount of DC power. In some examples, the controller may adapt the first amount of DC power and the second amount of DC power based on one or more control signals received from a foot pedal (e.g., foot pedal 118) and/or a start/stop input (e.g., start/stop input 1128). For example, when the start/stop input 1128 is pressed or the foot pedal 118 is released, the controller may be configured to increase the first amount of DC power and decrease the second amount of DC power. In some aspects, when the start/stop input 1128 is pressed or the foot pedal 118 is released, power regeneration may be initiated in which a braking force is applied to the motor and at least some of the power captured during braking is used to recharge the battery.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

What is claimed is:

1. A drain cleaner, comprising:
a cable;
a motor configured to rotate the cable; and
a power module mounted to the drain cleaner and comprising:
a rechargeable battery;
battery charging components;
a first connector configured to connect to a first power source; and
a power controller configured to distribute, from power received from the first power source, a first amount of power to the battery charging components and a second amount of power to the motor.

2. The drain cleaner of claim 1, wherein the power controller is configured to increase the second amount of power and decrease the first amount of power based on a signal from the motor.

3. The drain cleaner of claim 1, wherein the power controller is configured to decrease the second amount of power and increase the first amount of power based on a signal from the motor.

4. The drain cleaner of claim 1, wherein the power module is coupled to a foot pedal and to a start/stop input device, and wherein, based on the foot pedal being released and the start/stop input device being selected, a braking operation is applied to the motor, which transmits power to the battery charging components.

5. The drain cleaner of claim 1, wherein the power controller is configured to:
power the motor with the second amount of power; and
charge the rechargeable battery with the first amount of power distributed to the battery charging components while the motor is powered with the second amount of power,
wherein the rechargeable battery is configured to be mechanically and electrically connected to the drain cleaner during charging.

6. The drain cleaner of claim 1, wherein the first connector is a receptacle configured to connect to a power cable, and wherein the first power source is an AC electrical power source.

7. The drain cleaner of claim 1, wherein the power controller is further configured to distribute power from the rechargeable battery to the motor when power is not being received from the first power source.

8. The drain cleaner of claim 1, wherein the power controller is configured to increase the first amount of power based on the motor being turned off and power being received from the first power source.

9. The drain cleaner of claim 1, wherein the power module comprises a first section and a second section, wherein the first section comprises the rechargeable battery and the battery charging components and the second section comprises the power controller.

10. A drain cleaner, comprising:
a cable;
a DC motor configured to rotate the cable; and
a power module mounted to the drain cleaner and comprising:
a DC battery;
battery charging components configured to recharge the DC battery;
a first connector configured to connect to an AC power source;
a converter configured to convert AC power received through the first connector to DC power; and
a power controller configured to distribute, from the DC power, a first amount of the DC power to the battery charging components and a second amount of the DC power to the DC motor.

11. The drain cleaner of claim 10, wherein the power controller is configured to adapt the first amount of the DC power and the second amount of the DC power based on a change in a state of the DC motor.

12. The drain cleaner of claim 10, wherein the power controller is configured to distribute power from the DC battery to the DC motor when AC power is not being received through the first connector.

13. The drain cleaner of claim 10, wherein the power module is mounted to a portion of the drain cleaner that supports a cylindrical drum that houses the cable.

14. The drain cleaner of claim 10, wherein the power module comprises a first section and a second section, wherein the first section comprises the DC battery and the battery charging components and the second section comprises the power controller.

15. A power module for a drain cleaner, comprising:
a rechargeable battery;
battery charging components configured to recharge the rechargeable battery;
a first connector configured to connect to an AC power source;
a second connector configured to connect to a DC motor;
a converter configured to convert AC power received through the first connector to DC power; and
a controller configured to:
determine that the DC motor is in a first state;
determine a first amount of the DC power to distribute to the battery charging components and a second amount of the DC power to distribute to the DC motor based at least on the DC motor being in the first state; and
distribute the first amount of the DC power to the battery charging components and the second amount of the DC power to the DC motor through the second connector.

16. The power module of claim 15, wherein the controller is further configured to adapt the first amount of the DC power and the second amount of the DC power based on the DC motor transitioning from the first state to a second state.

17. The power module of claim 16, wherein the first state comprises a low power state and the second state comprises a high power state, wherein the controller is configured to decrease the first amount of the DC power and increase the second amount of the DC power based on the DC motor transitioning from the first state to the second state.

18. The power module of claim 16, wherein the first state comprises a high power state and the second state comprises a low power state, wherein the controller is configured to increase the first amount of the DC power and decrease the second amount of the DC power based on the DC motor transitioning from the first state to the second state.

19. The power module of claim 15, wherein the controller is configured to determine a state of the DC motor based on one or more signals from the DC motor and/or one or more signals from a motor drive system coupled to the DC motor.

20. The power module of claim 15, wherein the controller is further configured to determine the first amount of the DC power to distribute to the battery charging components and the second amount of the DC power to distribute to the DC motor based on an amount of AC power received through the first connector or an amount of the DC power produced by the converter from the AC power received through the first connector.
